(19) United States
(12) Patent Application Publication
(10) Pub. No.: US 2024/0264046 A1
(43) Pub. Date: Aug. 8, 2024

(54) FLUID COLLECTION WORKSTATION

(71) Applicant: Getty Box Gizmo LLC, Dickinson, ND (US)

(72) Inventor: Arthur Mark Hovde, West Dickinson, ND (US)

(21) Appl. No.: 18/431,781

(22) Filed: Feb. 2, 2024

Related U.S. Application Data
(60) Provisional application No. 63/482,835, filed on Feb. 2, 2023.

(51) Int. Cl. G01N 1/10

(52) U.S. Cl. CPC G01N 1/10

(57) ABSTRACT

Concepts presented herein relate to containment methods, systems and apparatus to assist in obtaining and testing fluid samples during loading and unloading of fluid to and from a containment assembly. The containment assembly includes a container supporting a transfer line and a lid coupled with the container. A tool storage device connected with the lid supports at least one testing device. An evacuator and sampling assembly is fluidly connected with the transfer line to evacuate the container and obtain samples from the transfer line.

### BACKGROUND

Current load line containment assemblies are used in transferring fluid (e.g., oil, water, liquids, condensate) from a first container to a second container. These assemblies include a lid and a container for receiving one or more connections. Current assemblies include connections to both a supply line and a transfer line. In some instances, users of the assemblies use one or more tools and/or fittings in connecting a line to the containment assembly and facilitating testing of fluid within the containment assembly.

### SUMMARY

Concepts presented herein relate to containment methods, systems and apparatus to assist in obtaining and testing fluid samples from a container assembly. In one embodiment, the container assembly forms a fluid collection workstation that includes a container supporting a transfer line and a lid coupled with the container. A tool storage device connected with the lid supports at least one testing device. An evacuator and sampling assembly is fluidly connected to assist with obtaining samples. For example, the container assembly can be attached to a fluid tank using a load line connector. The evacuator and sampling assembly can be used to obtain samples due to pressure from the fluid tank pushing fluid through an outlet of the evacuator and sampling assembly. The evacuator and sampling assembly can also be used to evacuate fluid from a bottom of the container.

### BRIEF DESCRIPTION OF THE DRAWINGS

FIG. 1 is a perspective view of a containment assembly in a closed position.

FIG. 2 is a perspective view of the containment assembly of FIG. 1 in an open position.

FIG. 3 is a sectional view of the containment assembly of FIG. 1.

FIG. 4 is a close-up, section view of a portion of the containment assembly of FIG. 1.

FIG. 5 is a side view of a lid of the containment assembly of FIG. 1, including a plurality of testing devices.

FIG. 6 is a perspective view of an evacuator and sampling assembly.

FIG. 7 is a sectional view of an alternative containment assembly.

FIG. 8 is a top, schematic view of an alternative tool storage device.

FIG. 9 is a perspective view of an alternative containment assembly.

FIG. 10 is a perspective view of an alternative evacuator and sampling assembly.

### DESCRIPTION

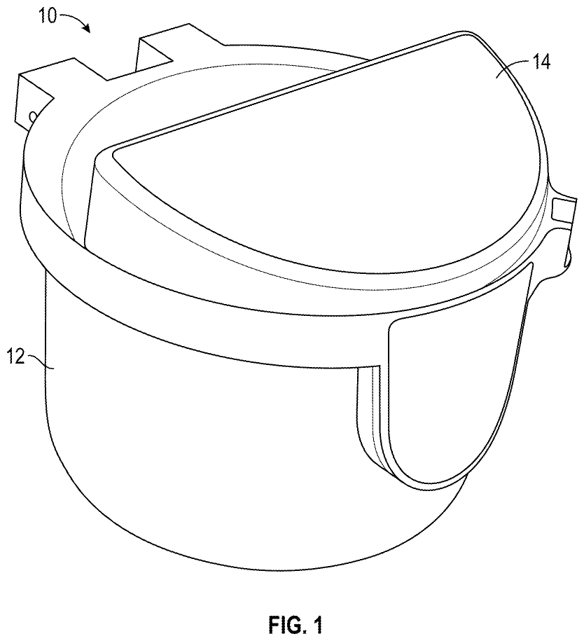

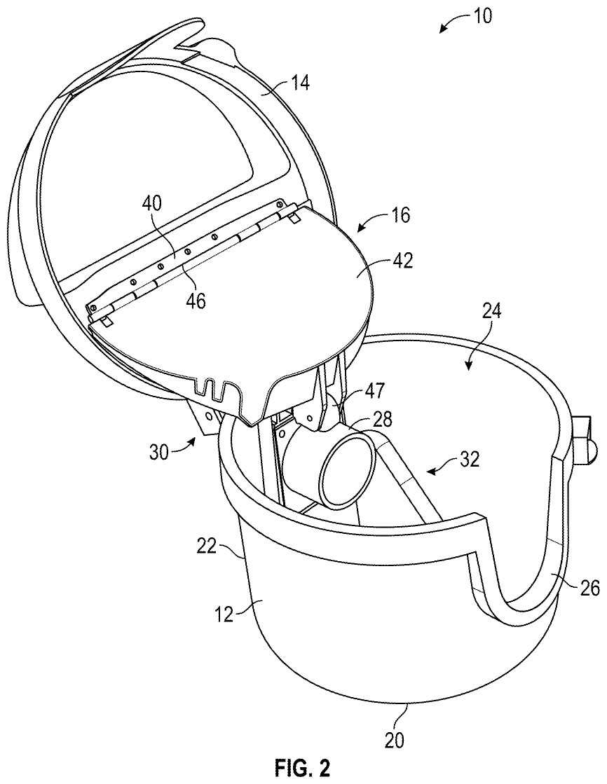

FIGS. 1 and 2 are exploded perspective views of an example load line containment assembly 10, with FIG. 1 showing the containment assembly 10 in a closed position and FIG. 2 showing the containment assembly 10 in an open position. Containment assembly 10 includes a container 12, a lid 14 and a tool storage device 16. Assembly 10 is configured to accept connections thereto when loading/unloading fluid such as oil, acid, water and/or hazardous waste from/to a vessel (e.g., a storage container, tank truck). In the embodiment illustrated, the lid 14 and tool storage device 16 are coupled together and configured to pivot with respect to the container 12. As discussed below, the containment assembly 10 can be used as a workstation for collection of samples from the container 12 and storage of testing devices onto the tool storage device 16. Further, a fluid delivery component can be incorporated into the tool storage device 16 and connected to the lid 14 to direct oil from an interior side of the lid to the container 12. In one embodiment, containment assembly 10 can include features as disclosed in U.S. Pat. No. 9,151,428, the contents of which are hereby incorporated by reference in their entirety.

Lid 14 can bear information easily displayed for a user. For example, lid 14 includes a top portion that is inclined and directed toward a front of the containment assembly 10 to indicate various information to a user standing in front of containment assembly 10, such as a well location, various unique identifiers, permit numbers, etc. Further, a front bill portion of the lid 14 can include information such as a logo, well type, etc. An inside of the lid 14 can include safety information, such as a pictorial checklist and/or other useful information.

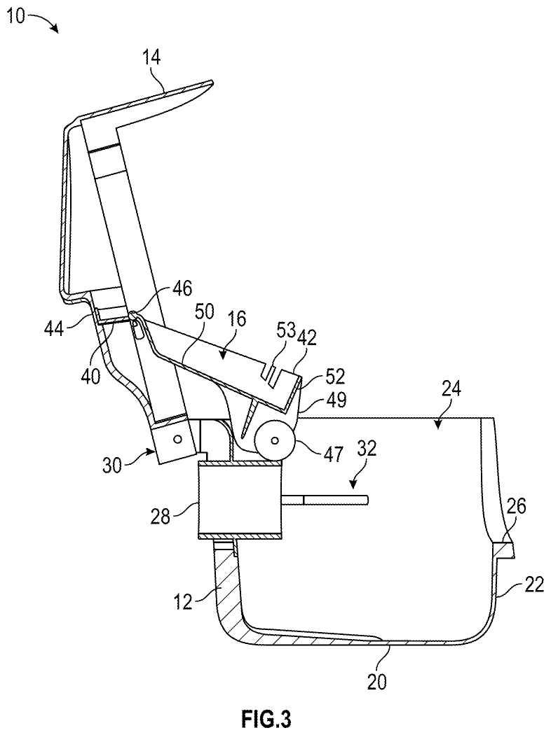

With further reference to FIG. 3, container 12 in one embodiment is formed of a unitary body, which forms a bottom 20 surrounded by an upwardly extending wall 22. The wall 22 extends from the bottom 20 to an upward opening 24 and further defines a line support 26 and a collar support 28. The collar support 28, in one embodiment, forms a pipe that receives a first connection (e.g., from a supply line) and a second connection (e.g., from a transfer line). The container 12 further defines a hinge assembly 30 connecting container 12 and lid 14.

When placed in service, assembly 10 is generally used in the transfer of fluid from a first tank (e.g., a storage tank at an oil field) to a second tank (e.g., a mobile tank positioned on a truck). The assembly 10 can be positioned in the closed configuration when not in use, whereby the lid 14 protects unwanted contaminants (e.g., dirt, leaves, birds, rodents) from entering container 12. A first line (e.g., a supply line or the like connected with a storage tank) is fluidly connected with the collar support 28 to supply fluid (e.g., oil) to the assembly 10. A transfer line (e.g., a hose or the like connected with a mobile tank) passes through the line support 26 and connects with the collar support 28, fluidly connecting the supply line and the transfer line. Coupled with the collar support 28 is a sampling and evacuation assembly 32. Assembly 32 can be used to obtain samples of fluid received from the supply line and/or evacuate fluid from a bottom of container 12, as will be discussed below.

Tool storage device 16 includes a first portion 40 coupled with lid 14 and a second portion 42 pivotally coupled with the first portion 40. First portion 40 is shaped to be secured to lid 14 using a lip 44 and follows along an inner profile of the lid 14 such that liquid is prevented from passing between first portion 40 and lid 14. As such, any liquid contacting first portion 40 is either maintained within first portion 40 or directed to second portion 42. In the embodiment illustrated, first portion 40 and second portion 42 are connected through a living hinge 46, although other approaches to connect first portion 40 and second portion 42 can be used (e.g., a piano hinge).

A user can operate to move the storage device 16 to a closed position by closing lid 14. As lid 14 closes, a wheel assembly 47 supports tool storage device 16 upon collar support 28, wherein tool storage device 16 moves forward with respect to the collar support 28. A foot 49 extending from a lower portion of the tool storage device 16 can support tool storage device 16 upon the collar support 28 when the lid 14 is in the closed position. Second portion 42 defines a fluid delivery component that includes a lower floor portion 50 surrounded by an annular wall 52. The floor portion 50 and annular wall 52 together form a funnel-like feature that directs fluid toward on outlet, which directs liquid into the container 12.

When filling a second tank using a transfer line, a user may remove a cap or plug positioned on collar support 28. Furthermore, the user may carry an end of the transfer line (e.g., using a T-shaped plug or cap) and position the transfer line within the container 12, with a portion of the line positioned on the line support 26. The user can then remove the plug or cap from the transfer line and position the plug or cap and/or other tools (e.g., sampling and testing devices) on the tool storage device 16. Next, the user connects an end of the transfer line to the collar support 28. Any excess oil or waste spilling off the tools collects within the tool storage device 16 and transfers to the container 12.

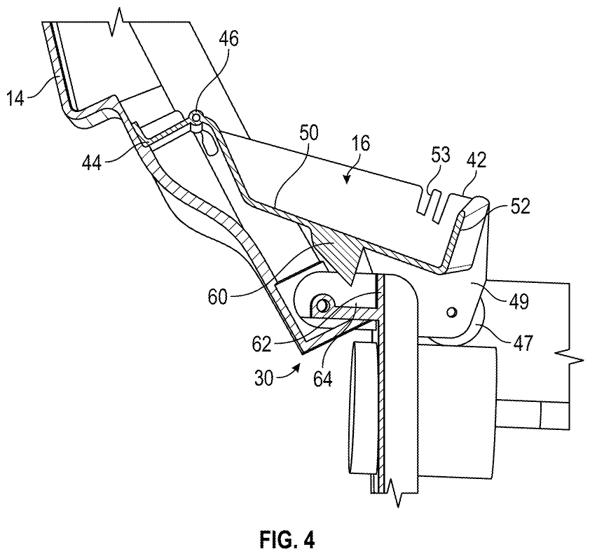

As illustrated in FIG. 4, tool storage device 16 can include a locking feature 60 (e.g., a kickstand) that engages an upper rim 62 of the container 12. As lid 14 is opened, locking feature 60 rides along an upper portion of the rim 62 before falling into a space 64 between upper rim 62 and hinge assembly 30. Contact between locking feature 60 and rim 62 prevents further rotation of lid 14 with respect to container 12. To release locking feature 60 and close lid 14, tool storage device 16 can be lifted (i.e., second portion 44 rotates about hinge 46) to allow locking feature 60 to exit space 64 and move to an opposite side of upper rim 62 than space 64. In a further embodiment, multiple locking features can be used along a bottom of tool storage device 16.

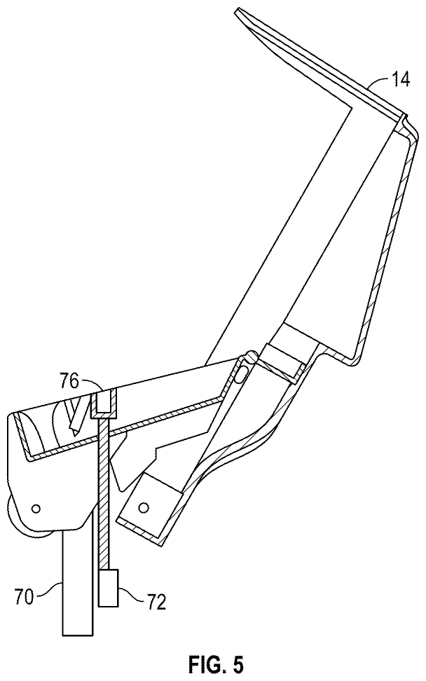

In addition to holding caps and plugs associated with container 12, tool storage device 16 can be useful in holding sampling and collection equipment, such as at least one testing device, thiefs, woodback thermometers, collection bottles, hydrometers, and other equipment. To that end, annular wall 52 can include one or more recesses 53 configured to receive a hook of a testing device or other device in a vertically oriented, suspended manner. In FIG. 5, for example, first testing device 70 and a second testing device 72 are supported by tool storage device 16. In the embodiment illustrated, the first testing device 70 is supported on one side of the tool storage device 16 and includes a hook (not shown). Second testing device 72 is positioned on an opposite side of tool storage device 16 and includes a hook 76. Hooks of the devices can engage corresponding recesses 53 in annular wall 52. The suspend testing devices 70 and 72, respectively, from tool storage device 16 and within container 12. In further embodiments, more recesses can be used to suspend other devices. Other forms of suspending testing devices can also be utilized. In one example, sampling from the assembly 32 can detect water in oil. In another embodiment, fluid exiting evacuation and sampling assembly 32 can be observed to determine a water content of oil exiting the assembly 32.

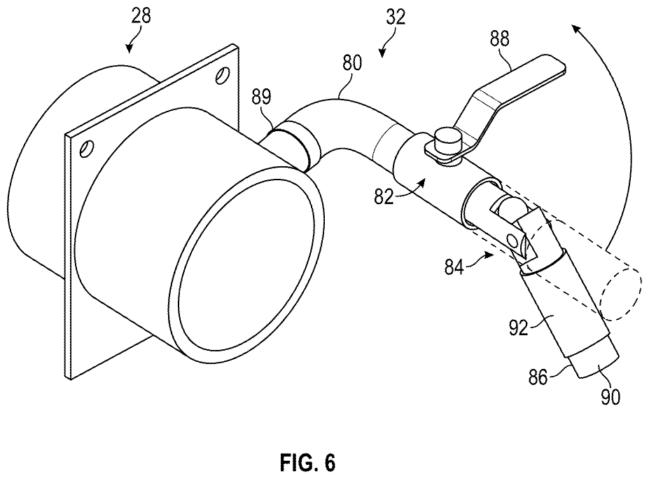

FIG. 6 is a perspective view of evacuation and sampling assembly 32. Assembly 32 includes an elbow portion 80 fluidly connected with collar support 28 and is configured to be rotatable with respect to the collar support 28 about a sealed joint 89. Elbow portion 80 is fluidly connected with a primary valve 82 (e.g., a ball valve), a secondary valve 84 and a distal segment 86 terminating at an opening 90. Primary valve 82 can be operated between open and closed positions using a suitable handle 88, allowing fluid flow therethrough in a first direction. Secondary valve 84 operates to direct flow from the primary valve 82 in a second direction different from the first direction. Additionally, secondary valve 84 can restrict flow of fluid through distal segment 86 (e.g., by rotating distal segment 86 with respect to primary valve 82) to opening 90. In one embodiment, distal segment 86 is formed of a rigid tube or pipe (e.g., formed of a metal such as iron or copper).

In an evacuation mode of assembly 32, elbow 80 is rotated about sealed joint 89 such that a tip of distal segment 86 is positioned to evacuate fluid from a bottom of container 12. In one embodiment, distal segment 86 can be rotated to meter flow through opening 90. Additionally, a user can orient distal segment 86 to aim flow through the opening 90 to a desired position (e.g., into a container or sampling device). Handle 88 is operated to move valve 82 between an open position and a closed position.

During use in the evacuation mode, vacuum within the line associated with collar support 28 causes fluid within container 12 to be evacuated from opening 90 through assembly 32. In one embodiment, a collar 92 can be slid from distal segment 86 over secondary valve 84 to prevent rotation of distal segment 86 with respect to primary valve 82 when primary valve 82 is aligned with distal segment 86. In a sampling mode of assembly 32, elbow 80 can be rotated upwardly to be more easily accessible to a user, for example to a position as shown in FIG. 3 or to a vertical position with respect to the collar support 28. Distal segment 86 can then be rotated upward to direct fluid flowing through assembly 32 and opening 90 to a bottle for collecting a sample. The collected sample can then be analyzed, for example using testing devices 70 and 72.

In one method of use, a user can use containment assembly 10 in obtaining samples for testing during loading fluid onto a truck, trailer or vessel. The user approaches containment assembly 10 and prepares to transfer fluid through the containment assembly 10 to the truck, trailer or vessel. For example, the user can remove any caps and/or plugs from collar support 28 and position these items onto the tool storage device 16. Next, a load line from the truck can be connected to collar support 28, which allows fluid from within the collar support 28 to flow to a tank on the truck. To transfer fluid to the truck, a valve (e.g., a sales valve) is opened between a tank and the collar support 28.

During an initial period of transfer, primary valve 82 of assembly 32 is in a closed position. The user can then obtain a sample from containment assembly 10 by positioning the assembly 32 in a sampling mode. To obtain the sample, elbow 80 is rotated upwards with respect to collar support 28. Distal segment 86 can be rotated with respect to primary valve 82 to prevent fluid from flowing through assembly 32 to opening 90. A sampling device (e.g., a bottle) can be positioned under an open end of distal segment 86. Valve 82 can then be put into an open position by operating handle 88 and distal segment 86 can be rotated to allow fluid (and to meter the fluid) to flow out of distal segment 86 into the sampling device. Fluid from the sampling device can then be transferred to a testing device such as a woodback thermometer or hydrometer floating within a thief. The testing devices can be supported by storage device 16 to allow completion of testing while fluid is still flowing to the truck. The sampling and testing process can be completed multiple times as desired to obtain and test multiple samples.

After the desired samples have been obtained, assembly 32 can be positioned in the evacuation mode. To move assembly 32 to the evacuation mode, elbow 80 is rotated downward such that distal segment 86 is proximate the bottom 20 of container 12. When distal segment 86 is aligned with valve 82, fluid flows therethrough. As distal segment is rotated with respect to valve 82, flow is restricted. Suction pressure from a pump on the truck evacuates fluid positioned in the bottom 20 of container 12, transferring fluid from the bottom 20, through assembly 32 and into the truck line.

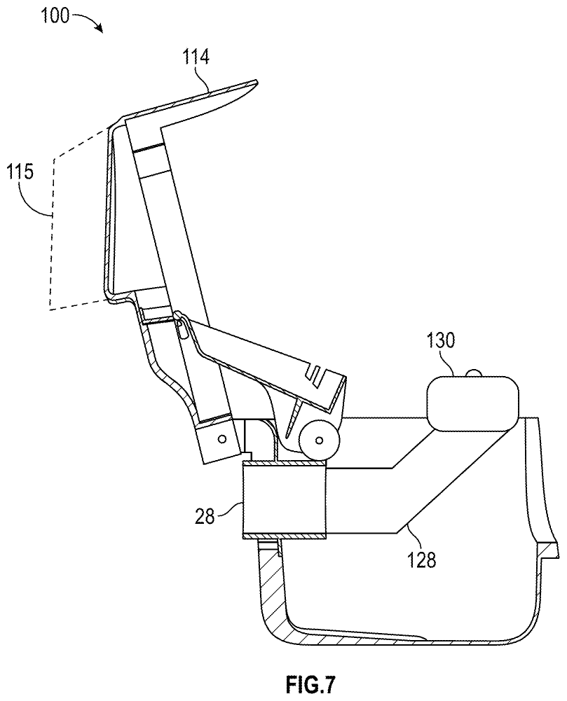

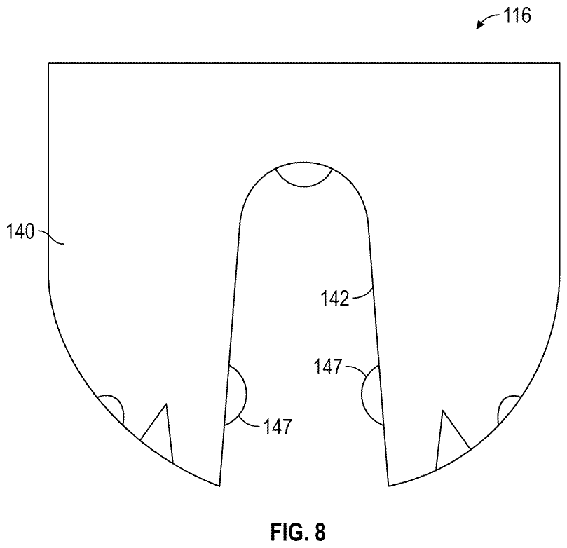

In a further embodiment illustrated in FIGS. 7 and 8, an alternative containment assembly 100 includes a modified lid 114 that includes an upper portion 115 (shown in phantom) that can accommodate a pipe extension 128 covered by a corresponding cap 130. Pipe extension 128 extends from collar support 28 at a 45-degree angle, although other angles can be used to provide easier access to connecting a transfer line to the collar support 28. FIG. 8 is a schematic view of an alternative tool storage device 116 that can be used to accommodate pipe extension 128. Tool storage device 116 includes a u-shaped floor 140 that defines an opening 142 that will surround pipe extension 128 when lid 114 is in the closed position. Additional wheel assemblies 147 can be positioned to support tool storage device 116 on pipe extension 128.

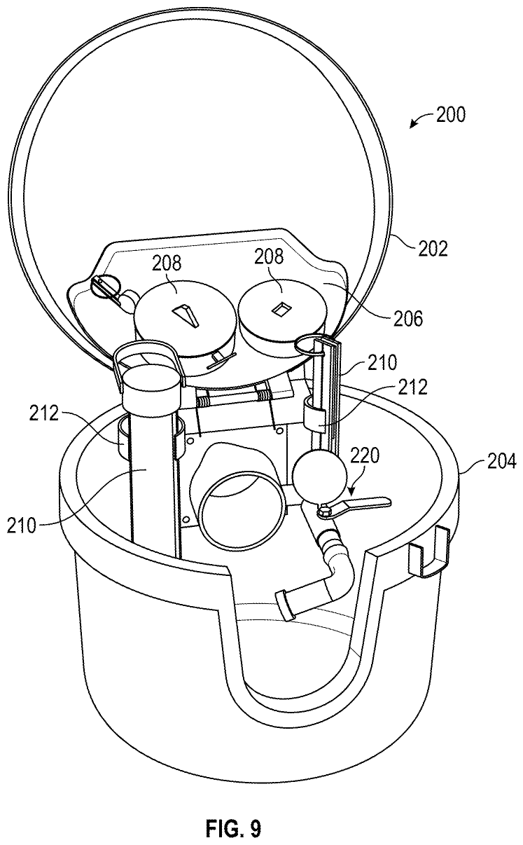

FIG. 9 illustrates an alternative load line containment assembly 200 that includes similar features to load line containment assembly 10 discussed above. Like containment assembly 10, containment assembly 200 includes a lid 202 connected with a container 204 and a tool storage device 206 supporting a plurality of components 208 thereon (e.g., a plug and cap). Additionally, tool storage device 206 supports testing devices 210, which are vertically oriented and suspended within the container 204, using clips 212 attached to the tool storage device 206. As illustrated, one or more biasing members 214 (e.g., springs) can bias tool storage device 206 in an open position.

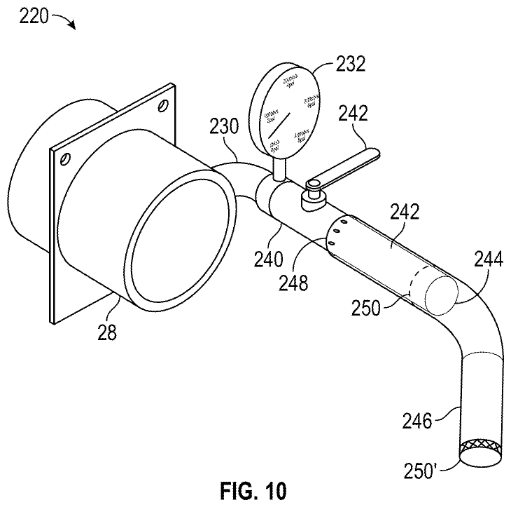

With additional reference to FIG. 10, containment assembly 200 includes an alternative sampling and evacuation assembly 220. Assembly 220 includes an elbow 230 extending from collar support 28 and fluidly connected with a pressure gauge 232. In one embodiment, pressure gauge 232 is a mechanical pressure gauge that indicates pressure applied through elbow 230. When collar support 28 is closed (e.g., with a cap positioned thereon to prevent fluid flow therethrough), pressure gauge 232 can be an indicator of an amount of fluid within a tank connected with collar support 28. For example, when pressure gauge 232 indicates a higher pressure, more fluid is within the tank. Conversely, when pressure gauge 232 indicates a lower pressure, less fluid is within the tank. This indication can prevent an operator from having to climb stairs or otherwise attempt to access a top of the tank to collect an indication of fluid level within the tank.

Assembly 220 further includes a primary valve 240 operated by a handle 242. Primary valve 240 restricts flow to a distal segment 242 that terminates at an opening 244. A secondary valve 246 is coupled with the distal segment 242 and is used to restrict flow from collar support 28 to containment assembly 200 and/or direct fluid flow from collar support 230 through opening 244. Secondary valve 246 is formed of a resilient tube extending from a first end 248 to a second end 250. In the embodiment illustrated, secondary valve 246 can transition from a first, retracted position to a second, extended position. First end 248 is secured to distal segment 242 at a selected position using a suitable fastener. In the retracted position of secondary valve 246, second end 250 is located proximal opening 244.

In the retracted position, fluid flowing through opening 244 is unrestricted. In the extended position (as illustrated by end 250′), secondary valve 246 can direct fluid flowing through opening 244 (i.e., from a first direction through primary valve 240 to a second direction different from the first direction), for example by an operator positioning second end 250 to direct fluid into a testing device. In addition, secondary valve 246 can be operated to close second end 250 to restrict fluid flowing through opening 244 from reaching containment assembly 200. In one embodiment, an operator can squeeze second end 250, thereby restricting fluid flow through assembly 220. In another embodiment, second end 250 can include a sealing device such as a duck bill valve, magnetic sealing element or other device to prevent fluid from flowing through second end 250. In a further embodiment, second end 250 can include a raised protrusion that can assist an operator in grasping and/or sealing second end 250 to direct fluid flow and/or restrict fluid flow therethrough.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A containment assembly, comprising:
a container;
a lid pivotally connected to the container through a hinge and configured to be positioned in an open configuration and a closed configuration;
at least one testing device;
a tool storage device connected to the lid and positioned to support the at least one testing device; and
an evacuation and sampling assembly including a primary valve and a secondary valve.

2. The containment assembly of claim 1, wherein the at least one testing device is configured to suspend from the tool storage device within the container.

3. The containment assembly of claim 1, further comprising a hook configured to couple the at least one testing device to the tool storage device.

4. The containment assembly of claim 1, wherein the tool storage device includes a floor portion and a wall extending from the floor portion.

5. The containment assembly of claim 4, wherein the at least one testing device is configured to be coupled to the wall.

6. The containment assembly of claim 1, wherein the evacuation and sampling assembly includes an elbow rotatable with respect to the container.

7. The containment assembly of claim 6, wherein a rotatable joint connects the elbow to the container.

8. The containment assembly of claim 1, wherein the secondary valve includes a distal segment rotatable with respect to the primary valve.

9. The containment assembly of claim 1, wherein the secondary valve secondary valve is a resilient tube configured to transition from a first, retracted position to a second, extended position.

10. The containment assembly of claim 1, wherein the at least one testing device is a thermometer.

11. The containment assembly of claim 1, wherein the evacuation and sampling assembly incudes a pressure gauge.

12. A method of testing a sample of fluid from a containment assembly, comprising:
accessing an evacuation and sampling assembly within a container of the containment assembly, the evacuation and sampling assembly including an elbow, a primary valve, a secondary valve and a distal segment;
operating the primary valve to allow fluid to flow through the primary valve in a first direction; and
directing fluid flow from the primary valve in a second direction different from the first direction using the secondary valve.

13. The method of claim 12, further comprising:
rotating a distal segment of the evacuation and sampling assembly with respect to the container;
obtaining the sample from the distal segment;
positioning the sample in a testing device; and
supporting the testing device with a tool storage device connected to the container such that the testing device is suspended within the container.

14. The method of claim 12, wherein the evacuation and sampling assembly includes an elbow rotatable with respect to the container.

15. The method of claim 14, wherein a rotatable joint connects the elbow to the container.

16. The method of claim 12, wherein the distal segment is rotatable with respect to the primary valve.

17. The method of claim 12, wherein the secondary valve secondary valve is a resilient tube configured to transition from a first, retracted position to a second, extended position.
